(19) United States
(12) Patent Application Publication
(10) Pub. No.: US 2012/0245711 A1
(43) Pub. Date: Sep. 27, 2012

(54) MULTI-LINKAGE AND MULTI-TREE STRUCTURE SYSTEM AND METHOD OF CONTROLLING THE SAME

(75) Inventor: In-gyu PARK, Changwon-city (KR)

(73) Assignee: SAMSUNG TECHWIN CO., LTD., Changwon-city (KR)

(21) Appl. No.: 13/349,159

(22) Filed: Jan. 12, 2012

(30) Foreign Application Priority Data
Mar. 22, 2011 (KR) 10-2011-0025388

(51) Int. Cl. G05D 3/12; F16C 11/00

(52) U.S. Cl. 700/13; 403/53

(57) ABSTRACT

A multi-linkage and multi-tree structure system includes: a base body including a sensor for detecting movement of the base body; at least one link body which is connected to the base body via at least one first joint and moves relative to the base body with respect to at least one axis, wherein movement of the at least one link body is independently controlled based on the movement of the base body detected by the sensor, and wherein each of the at least one link body comprises one or more links that are connected to one another via at least one second joint, and at least one link in each of the at least one link body is controlled by the controller to orient toward a set direction with respect to the movement of the base body.

### CROSS-REFERENCE TO RELATED PATENT APPLICATION

This application claims priority from Korean Patent Application No. 10-2011-0025388, filed on Mar. 22, 2011, in the Korean Intellectual Property Office, the disclosure of which is incorporated herein in its entirety by reference.

### BACKGROUND

1. Field

Apparatuses and methods consistent with exemplary embodiments relate to a multi-linkage and multi-tree structure system, and more particularly, to a multi-linkage and multi-tree structure system, in which at least one or more link structures are kinematically connected to a common base body.

2. Description of the Related Art

A plurality of link structures may be kinematically connected to a common base body to form a multi-linkage and multi-tree structure system. Here, a movement sensor may be installed on an end portion in each of the link structures to sense movement of each link structure.

However, the movement sensor may be exposed to an excessive noise component due to an elastic effect of joints included in each of the link structures, that is, due to low kinematical inertia. In this case, a system controlling characteristic with respect to each of the link structures may degrade.

On the other hand, each of the link structures connected to the base body needs to maintain a set orientation. In addition, the base body may be shaken by internal or external causes. In this case, it is needed to constantly maintain orientation of each link structure to stabilize the link structures.

### SUMMARY

One or more exemplary embodiments provide a multi-linkage and multi-tree structure system, in which one or more link structures are kinematically connected to a common base body and each of the link structures may be independently stabilized by using a sensor mounted on the base body, and a method of controlling the multi-linkage and multi-tree structure system.

According to an aspect of an exemplary embodiment, there is provided a multi-linkage and multi-tree structure system, the system comprising: a base body including a sensor for detecting movement of the base body; at least one link body which is connected to the base body via at least one first joint and moves relative to the base body with respect to at least one axis, wherein movement of the at least one link body is independently controlled based on the movement of the base body detected by the sensor, and wherein each of the at least one link body comprises one or more links that are connected to one another via at least one second joint, and at least one link in each of the at least one link body is controlled by the controller to orient toward a set direction with respect to the movement of the base body.

The at least one link, which is controlled to orient toward the set direction with respect to the movement of the base body, may be at least one last link included in the at least one link body, respectively.

The movement of the base body detected by the sensor may be transformed into movement of the at least one last link by reflecting movements of the at least one first joint and the at least one second joint.

The sensor may comprise at least one of a gyro sensor for measuring an angular velocity of the base body with respect to at least one axis, an inclinometer sensor for measuring a rotating angle with respect to the at least one axis, and a rotation detector.

Coordinate values of at least one last link respectively included in the at least one link body with respect to an absolute coordinate system may be obtained by using a value measured by the inclinometer sensor and movements of the at least one first joint and the at least one second joint, to compensate for an error caused by the gyro sensor.

The multi-linkage and multi-tree structure system further may comprise: an angular velocity calculator for calculating angular velocities of at least one third joint connecting the base body and a fixed body on which the base body is fixed, the at least one first joint and at least one second joint by using the movement of the base body and movements of the at least one first joint and the at least one second joint; a controller for receiving differences between reference angular velocities and the calculated angular velocities to calculate controlling amounts; and a driver for driving the at least one first joint, the at least one second joint and the at least one third joint, according to the controlling amounts.

The at least one first joint, the at least one second joint and the at least one third joint may be driven so that variation rates of the calculated angular velocities form a trapezoidal shape with respect to time.

The base body may be mounted on a vehicle, a weapon module is mounted on one of the at least one link body, and a camera module is mounted on another one of the at least one link body.

According to an aspect of an exemplary embodiment, there is provided a method of controlling a multi-linkage and multi-tree structure system, in which at least one link body is connected to a base body via at least one first joint, wherein the at least one link body is capable of moving relative to the base body, and the base body comprises a sensor for detecting movement of the base body, the method comprising: controlling movement of the at least one link body independently based on the movement of the base body detected by the sensor, wherein each of the at least one link body comprises one or more links that are connected to one another via at least one second joint, and at least one link in each of the at least one link body is controlled to orient toward a set direction with respect to the movement of the base body.

The movement of the base body detected by the sensor may be transformed into movement of the at least one last link by reflecting movements of the at least one first joint and the at least one second joint.

The method further may comprise: calculating angular velocities of at least one third joint connecting the base body and a fixed body on which the base body is fixed, the at least one first joint and the at least one second joint by using the movement of the base body and movements of the at least one first joint and the at least one second joint; receiving differences between reference angular velocities and the calculated angular velocities and calculating controlling amounts; and driving the at least one first joint, the at least one second joint and the at least one third joint, according to the controlling amounts.

The movement of the base body and the movements of the at least one first joint and the at least one second joint may be measured by respective angles of rotation, and the angular velocities of the at least one first joint, the at least one second joint and the at least one third joint may be calculated by further using angular velocities of the base body calculated by the sensor.

Coordinate values of at least one last link included in the at least one link body, respectively, with respect to an absolute coordinate system are obtained by using a value measured by an inclinometer sensor installed in the base body and movements of the at least one first joint and the at least one second joint, to compensate for an error caused by a gyro sensor.

The method further may comprise: calculating a rotating angle of a first body, among the at least one link body comprising the first body and a second body, in a vertical direction and a horizontal direction to change a current orientation of the first body to a target orientation; generating a driving trajectory of the first body; and driving the first body according to the driving trajectory.

The method further may comprise: controlling the first body and a second body of the at least one link body to face the same orientation in the vertical and horizontal directions.

The method may comprise: generating the driving trajectory such that variation rates of angular velocities of at least one third joint connecting the base body and a fixed body on which the base body is fixed, the at least one first joint and the at least one second joint form a trapezoidal shape with respect to time; and generating feedback input values of the angular velocities so that the first body faces the target orientation.

The method further may comprise: calculating a current orientation of the first body; calculating a target orientation of the first body; driving the first body along with a trapezoidal trajectory; and compensating for a difference between the current orientation and the target orientation by feedback controlling.

### BRIEF DESCRIPTION OF THE DRAWINGS

The above and other aspects will become more apparent by describing in detail exemplary embodiments with reference to the attached drawings, in which:

FIG. 1 is a schematic diagram showing a remote weapon system as an example of a multi-linkage and multi-tree structure system according to an exemplary embodiment;

FIG. 2 is a schematic diagram showing a control structure of the remote weapon system shown in FIG. 1, according to an exemplary embodiment;

FIGS. 3A and 3B are flowcharts illustrating a method of trajectory adjustment and/or lead compensating as an example of a method of controlling a multi-linkage and multi-tree structure system, according to an exemplary embodiment;

FIG. 4 is a schematic diagram showing trajectory adjustment performed by the remote weapon system of FIG. 1, according to an exemplary embodiment; and

FIGS. 5 and 6 are schematic diagrams showing trajectory adjustment performed by the remote weapon system of FIG. 1 with respect to a disturbance, according to an exemplary embodiment.

### DETAILED DESCRIPTION OF THE EXEMPLARY EMBODIMENTS

Hereinafter, exemplary embodiments will be described with reference to accompanying drawings.

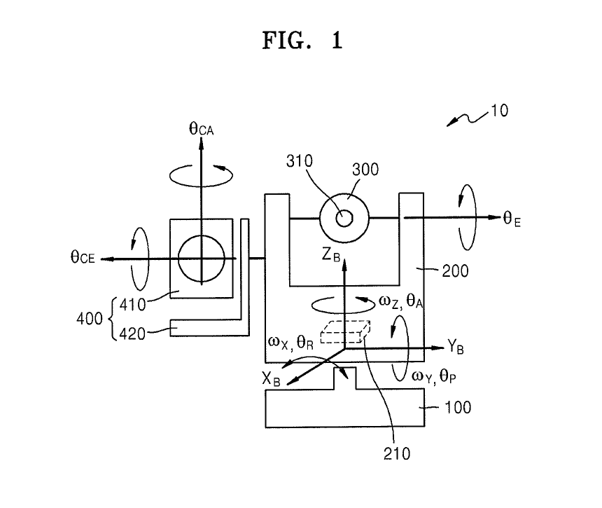

FIG. 1 shows a remote weapon system 10 as an example of a multi-linkage and multi-tree structure system according to an exemplary embodiment.

Referring to FIG. 1, the remote weapon system 10 includes a base body 200, a first body 300, and a second body 400.

The first body 300 is connected to the base body 200, and may move relative to the base body 200 with respect to at least one axis. The second body 400 is connected to the base body 200, and may move relative to the base body 200 with respect to at least one axis. At least one of or each of the first body 300 and the second body 400 may be independently controlled.

A sensor 210 for detecting movement of the base body 200 may be mounted in the base body 200. In addition, at least one of or each of movements of the first body 300 and the second body 400 may be independently controlled based on the movement of the base body 200, which is detected by the sensor 210.

According to the present exemplary embodiment, at least one or more link structures, for example, the first and second bodies 300 and 400, are kinematically and commonly connected to the base body 200, and at least one of or each of the first and second bodies 300 and 400 may be independently stabilized by using the sensor 210 mounted in the base body 200. Herebelow, however, the inventive concept will be described for a case in which each of the first and second bodies 300 and 400 is independently stabilized by using the sensor mounted in the base body 200.

The base body 200 may be fixedly or moveably connected to an additional supporting body 100. The base body 200 may move relative to the supporting body 100 with respect to at least one axis. In the exemplary embodiment shown in FIG. 1, the base body 200 is driven relative to the supporting body 100 with respect to a first axis, for example, an axis Z_{B}.

The base body 200 may be mounted on a vehicle and moveable with respect to at least one axis. In this case, the supporting body 100 may be fixed on the vehicle. The first body 300 and the second body 400 may each include at least one or more links that are connected to one another via joints.

A weapon module 310 capable of shooting and/or firing on a target may be mounted on the first body 300, according to the present exemplary embodiment. A camera module 410 for receiving input images may be mounted on the second body 400, according to the present exemplary embodiment. Therefore, the weapon module 310 of the first body 300 and the camera module 410 of the second body 400 may be mounted on a common vehicle. According to another exemplary embodiment, different modules instead of the weapon module 310 and the camera module 410 may be mounted on the first and second bodies 300 and 400, respectively.

The first body 300 and the second body 400 may each include at least one or more links. Here, the weapon module 310 may be mounted on a last link of the first body 300 or may be the last link of the first body 300. The camera module 410 may be mounted on a last link of the second body 400 or may be the last link of the second body 400.

On the other hand, the inventive concept is not limited to the present exemplary embodiment, and the weapon module 310 and the camera module 410 may be respectively mounted on or be other links of the first body 300 and the second body 400.

Movement of the base body 200 detected by the sensor 210 mounted on the base body 200 may be used to determine movements of the weapon module 310 and the camera module 410. Accordingly, each of the weapon module 310 and the camera module 410 may be independently controlled by detecting the movement of the base body 200.

At this time, the movement of the base body 200 may be transformed into the movements of the weapon module 310 and the camera module 410 by using movements of joints connecting the base body 200 to the first body 300 and the second body 400 and movements of joints connecting internal links to one another in each of the first body 300 and the second body 400.

In this case, the weapon module 310 and the camera module 410 may each include a joint encoder without an additional sensor. However, the movements of the weapon module 310 and the camera module 410 may be calculated from the movement of the base body 200, which are detected by the sensor 210 mounted on the base body 200.

Therefore, the remote weapon system 10 may stably perform controlling of the link structures, for example, the first and second bodies 300 and 400, which are commonly mounted on the base body 200, by using the sensor 210 instead of a relatively great number of sensors.

In the exemplary embodiment shown in FIG. 1, the base body 200 may be connected to the supporting body 100 and moved according to a rotation angle θ_{A} via one joint with respect to the axis Z_{B}. A base coordinate system X_{B}, Y_{B}, and Z_{B} may be set on the base body 200. In this case, movements with respect to an absolute coordinate system of the base body 200 may be defined by angular velocities ω_{X}, ω_{Y}, and ω_{Z} and rotating angles θ_{R}, θ_{P}, and θ_{A} with respect to reference axes of the base coordinate system X_{B}, Y_{B}, and Z_{B}.

The first body 300 may include one link including the weapon module 310 and one joint for rotating about an axis. The movement of the weapon module 310 with respect to the base body 200 may be defined as a movement corresponding to a rotating angle θ_{E} of the joint.

The second body 400 may include links respectively including the camera module 410 and a camera base 420, a joint connecting the base body 200 to the camera base 420, and a joint connecting the camera base 420 to the camera module 410. Here, the movement of the camera module 410 with respect to the base body 200 may be defined as movements corresponding to rotating angles θ_{CE} and θ_{CA} of the joints.

The weapon module 310 and the camera module 410 may each be controlled to be stabilized so as to be oriented along a set or predetermined direction with respect to the movement of the base body 200 and/or movement of the supporting body 100. That is, even when the vehicle on which the weapon module 310 and the camera module 410 are commonly mounted moves, the weapon module 310 and the camera module 410 may maintain the set orientation.

To do this, the sensor 210 mounted on the base body 200 may sense movement of the vehicle, and the orientation direction of the weapon module 310 and the camera module 410 may be controlled to compensate for the movement.

The sensor 210 may include at least one of a gyro sensor for measuring an angular velocity with respect to at least one axis, for example, angular velocities ω_{X}, ω_{Y}, and ω_{Z}, an inclinometer sensor for measuring a rotating angle with respect to at least one axis, for example, rotating angles θ_{R} and θₚ, and a rotation detector.

In addition, an encoder for measuring a rotating angle may be installed on each of the joints. Here, each of the rotating angles θ_{A}, θ_{E}, θ_{CE}, and θ_{CA} of the joints may be detected by each of the encoders installed on the joints.

The movement of the base body 200 detected by the sensor 210 may be transformed into movements of the last links of the first and second bodies 300 and 400 by reflecting the movements of the joints between the base body 200 and the first and second bodies 300 and 400 and the movements of the joints included in the first and second bodies 300 and 400.

The movement of the joint between the base body 200 and the first body 300 is measured as the rotating angle θ_{E} of the joint, and the movement of the joint between the base body 200 and the second body 400 is measured as the rotating angle θ_{CE} of the joint. In addition, the movement of the joint between the camera base 420 and the camera module 410 included in the second body 400 may be measured as the rotating angle θ_{CA} of the joint. Again, the last links of the first body 300 and the second body 400 may be the weapon module 310 and the camera module 410, respectively.

Therefore, the movements of the weapon module 310 and the camera module 410 may be calculated from the movement of the base body 200 detected by the sensor 210 by using a Denavit-Hartenberg (DH) parameter.

In general, the links corresponding to the first and second bodies 300 and 400 may be modeled as rigid bodies. In addition, in a tool including links that are modeled as rigid bodies, for example, a robot, if information about relative movements between an arbitrary link and a neighboring link is obtained, an angular velocity of another neighboring link may be calculated. For example, angular velocities of the first body 300 and the second body 400 may be calculated from sums of an angular velocity of the base body 200 and angular velocities of the joints connecting the base body 200 to the first body 300 and the second body 400, respectively.

Therefore, a value measured by a gyro sensor of the base body 200 may be transformed into a measurement value of the weapon module 310. Here, stabilization of the weapon module 310 and the camera module 410 refer to controlling of the joints in the first body 300 and the second body 400 so as to maintain the constant orientation of the weapon module 310 and the camera module 410 even when a disturbance is affecting the base body 200.

That is, angular velocities of the last joints in the weapon module 310 and the camera module 410 are maintained to be ‘0’. At this time, in the first body 300 and the second body 400, one joint is controlled if there is one joint, and two joints are controlled if there are two joints.

There may be a drift in a gyro sensor that is generally used in stabilization due to environment or internal problems. This drift phenomenon may non-linearly increase according to a degree of system disturbance. An increase in drift in the sensor may cause the orientation direction of the weapon module 310 and that of the camera module 410 to be different from intended directions in during stabilization thereof. In addition, trajectory adjustment and/or lead compensation may not be performed accurately due to the drift.

Here, the drift of the gyro sensor may be compensated by obtaining a status of the remote weapon system 10 with respect to the absolute coordinate system by using one or more inclinometer sensors or accelerometers mounted on the base body 200 and each of the encoders mounted on the joints.

In order to compensate for an error caused from the gyro sensor, coordinate values of the last links in the first body 300 and the second body 400 with respect to the absolute coordinate system are obtained by using value measured by the inclinometer sensors or the accelerometers, the movements of the joints between the base body 200 and the first and second bodies 300 and 400, and the movements of the joints included in the first and second bodies 300 and 400.

Therefore, the drift phenomenon of the gyro sensor may be compensated by obtaining the coordinate values of the last links in the first and second bodies 300 and 400 with respect to the absolute coordinate system from the values measured by the inclinometer sensors or the accelerometers.

Accordingly, even if there is a disturbance affecting the remote weapon system 10 during shooting of the weapon module 310, the weapon module 310 may be stably maintained oriented toward a target.

The gyro sensor may be mounted on the weapon module 310 and the camera module 410. However, the gyro sensor may be exposed to excessive noise components due to an elastic effect that is caused by low mechanical rigidity of the joints. Accordingly, system controlling characteristics may be degraded.

Therefore, the gyro sensor may be mounted on a portion having high rigidity, for example, on the base body 200, in the remote weapon system 10. In this case, since the base body 200 and the first and second bodies 300 and 400 are connected to each other kinematically, values measured by the gyro sensor in the base body 200 may be transformed into values with respect to the weapon module 310 and the camera module 410 so as to indirectly stabilize the weapon module 310 and the camera module 410.

In addition, the trajectory adjustment and/or lead compensation may be performed stably without regard to effects of disturbances such as roads or waves affecting the vehicle (for example, car, ship), on which the remote weapon system 10 is mounted, when operating the remote weapon system 10. At this time, sub-systems may be independently stabilized by using a single gyro sensor. In addition, the drift of the gyro sensor may be minimized when a disturbance is applied to the system 10 while the remote weapon system 10 is moved by the vehicle.

According to the above exemplary embodiment, the remote weapon system 10 includes two-link structure, in which the first and second bodies 300 and 400 are connected to one base body 200. However, the inventive concept is not limited to the above exemplary embodiment. The inventive concept may apply to only one link structure or three or more link structures connected to one or more base bodies.

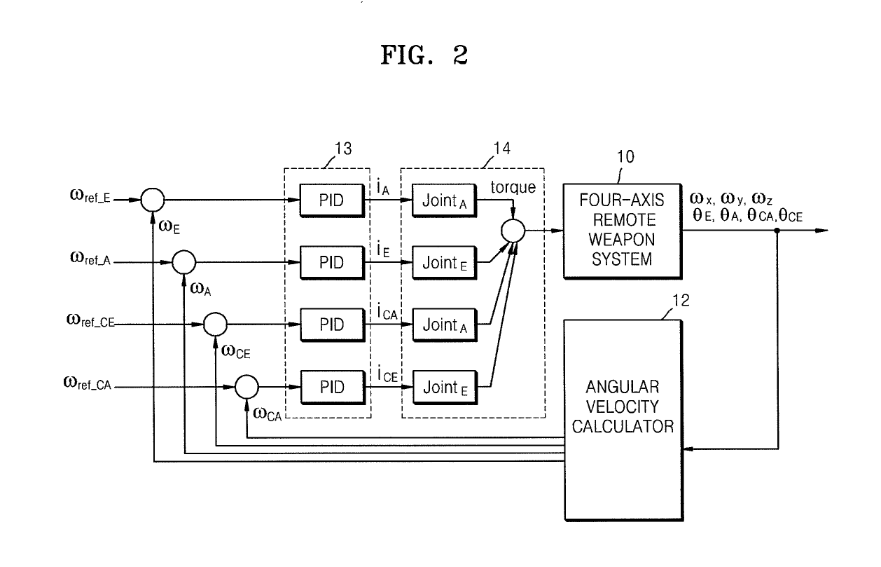

FIG. 2 is a schematic diagram showing a structure for controlling the remote weapon system 10 of FIG. 1, according to an exemplary embodiment.

Referring to FIG. 2, the remote weapon system 10 includes an angular velocity calculator 12, a controller 13, and a driver 14.

The angular velocity calculator 12 may calculate angular velocities ω_{A}, ω_{E}, ω_{CE}, and ω_{CA} of the joints from the movement of the base body 200 (θ_{A}), the movements of the joints between the base body 200 and the first and second bodies 300 and 400 (θ_{E} and θ_{CE}), and the movements of the joints included in the first and second bodies 300 and 400 (θ_{CA}).

Here, the angular velocities ω_{A}, ω_{E}, ω_{CE}, and ω_{CA} may be calculated by using the rotating angles of the joints (θ_{A}, θ_{E}, θ_{CE}, and θ_{CA}) output from the four-axis remote weapon system 10 and values ω_{X}, ω_{Y}, and ω_{Z} measured by the gyro sensor.

The controller 13 receives differences between reference angular velocities ω_{ref}_{_{—}}_{A}, ω_{ref}_{_{—}}_{E}, ω_{ref}_{_{—}}_{CE}, and ω_{ref}_{_{—}}_{CA} of the joints and the calculated angular velocities ω_{A}, ω_{E}, ω_{CE}, and ω_{CA}, and calculates controlling amounts i_{A}, i_{E}, i_{CE}, and i_{CA}. The driver 14 drives each of the joints according to the controlling amounts i_{A}, iₑ, i_{CE}, and i_{CA}.

Here, according to the controlling structure shown in FIG. 2, the last links in the first body 300 and the second body 400, for example, the weapon module 310 and the camera module 410, may be feedback-controlled so as to orient toward a set direction with respect to the movement of the base body 200. Therefore, the last links in the first body 300 and the second body 400, for example, the weapon module 310 and the camera module 410, may be stabilized so as to orient toward the set direction even when the base body 200 moves.

During stabilization of the remote weapon system 10, the direction in which the weapon module 310 and the camera module 410 are oriented is not changed. Therefore, the reference angular velocities ω_{ref}_{_{—}}_{A}, ω_{ref}_{_{—}}_{E}, ω_{ref}_{_{—}}_{CE}, and ω_{ref}_{_{—}}_{CA} corresponding to changes of the orientation direction may be set to be 0.

During stabilization, the angular velocities ω_{X}, ω_{Y}, and ω_{Z} of the base body 200 measured by the gyro sensor in response to a disturbance are to be transformed into angular velocities ω_{E} and ω_{CA} of the last links. The transformation may be performed by using the angular velocity calculator 12.

The angular velocity calculator 12 may calculate the angular velocities ω_{E} and ω_{CA} of the last links through a process of propagating angular velocities from the base body 200 toward the last links of the link structures. The above calculation may be performed by applying the Euler Angle method.

At this time, coordinates of each of bodies and links may be represented by a general DH parameter in order to represent the Euler Angle. According to the propagation of the angular velocities, the angular velocities of the weapon module 310 and the camera module 410 may be calculated by using the gyro sensor mounted on the base body 200.

In order to stabilize rotating movement and elevation movement of the weapon module 310, the angular velocity ω_{A} of the base body 200 and the angular velocity ω_{E} of the weapon module 310 are fed-back and stabilization control is performed by using the reference angular velocities ω_{ref}_{_{—}}_{A} and ω_{ref}_{_{—}}_{E}.

In addition, since the camera module 410 is stabilized based on two axes, two feedback control operations are required. That is, two angular velocity components ω_{CE} and ω_{CA} are fed-back and stabilization control is performed by using the reference angular velocities ω_{ref}_{_{—}}_{CE} and ω_{ref}_{_{—}}_{CA}.

On the other hand, when fluctuations of the vehicle, on which the remote weapon system 10 is mounted, are applied to the remote weapon system 10, the fluctuations may be overcome without regard to whether a current operating state of the remote weapon system 10 is a stabilized state, and thus, an accurate three-dimensional trajectory adjustment and/or lead compensation may be realized.

To do this, a weapon vector of the weapon module 310 at a time when a trajectory adjustment and/or lead compensation command are generated may be calculated based on the absolute coordinate system by using information of the inclinometers installed on the base body 200. At this time, the trajectory adjustment and/or lead compensation may be performed by the calculated weapon vector.

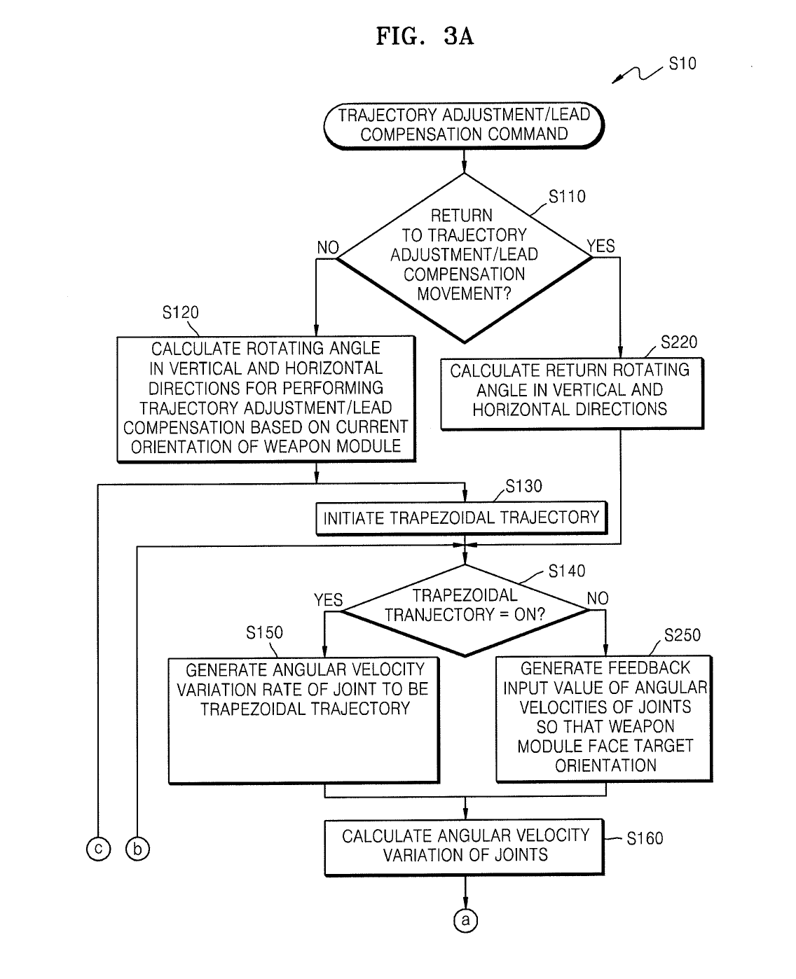

The trajectory adjustment and/or lead compensation may be performed according to processes shown in the flowcharts of FIGS. 3A and 3B.

FIGS. 3A and 3B are flowcharts illustrating a method of trajectory adjustment and/or lead compensation (S10) in a method of controlling a multi-link and multi-tree structure system, according to an exemplary embodiment. The controlling method of the present exemplary embodiment is applied to the remote weapon system 10 of FIG. 1. Therefore, the remote weapon system 10 will be described hereinafter, and description of elements that are the same as those already described with respect to the remote weapon system 10 of FIG. 1 are omitted.

Referring to FIGS. 3A and 3B, the remote weapon system 10 includes the first body 300 and the second body 400 connected to the base body 200, on which the sensor 210 for detecting the movements of the base body 200 is installed. The first body 300 and the second body 400 are capable of moving relative to the base body 200. According to the method of controlling a multi-link and the multi-tree structure system, the movements of the first body 300 and the second body 400 may be independently controlled based on the movement of the base body 200, which is detected by the sensor 210.

According to the present exemplary embodiment, in the remote weapon system 10 including at least one or more link structures (for example, the first and second bodies 300 and 400) that are kinematically and commonly connected to the base body 200, each of the first and second bodies 300 and 400 may be independently stabilized by using the sensor 210 mounted on the base body 200.

In addition, the remote weapon system 10 is stably controlled with respect to the first and second bodies 300 and 400 commonly mounted on the base body 200 by using the sensor 210 instead of a relatively great number of sensors.

Here, at least one of the links included in each of the first body 300 and the second body 400 or the last link in each of the first and second bodies 300 and 400 may be controlled to orient toward a set direction with respect to the movement of the base body 200.

Therefore, the weapon module 310 and the camera module 410 may be stabilized so as to orient toward a set direction or a constant direction with respect to the movement of the base body 200 and/or the movement of the supporting body 100. That is, even when the vehicle on which the weapon module 310 and the camera module 410 are commonly mounted moves, the orientation direction of the weapon module 310 and the camera module 410 may be maintained.

The movement of the base body 200 detected by the sensor 210 mounted on the base body 200 may be transformed into the movement of each of the weapon module 310 and the camera module 410. Accordingly, each of the weapon module 310 and the camera module 410 may be independently controlled by detecting the movement of the base body 200.

Here, the movement of the base body 200 may be transformed into the movements of the weapon module 310 and the camera module 410 by using the movements of the joint connecting the base body 200 to the first body 300 and the second body 400, and the movements of the joints connecting internal links in each of the first body 300 and the second body 400.

In this case, the weapon module 310 and the camera module 410 may include joint encoders without an additional sensor. However, the movements of the weapon module 310 and the camera module 410 may be calculated from the movement of the base body 200 detected by the sensor 210 mounted on the base body 200.

Therefore, the link structures, for example, the first and second bodies 300 and 400 mounted commonly on the base body 200, may be stably controlled by using the sensor 210 instead of a relative great number of sensors in the remote weapon system 10.

The stabilization control method of the weapon module 310 and the camera module 410 may be performed by the controlling structure shown in FIG. 2. The stabilization control method may include processes of calculating angular velocities, calculating controlling amounts, and driving joints.

In calculating of the angular velocities, the angular velocities ω_{A}, ω_{E}, ω_{CE}, and ω_{CA} of the joints may be calculated from the movement of the base body 200 (θ_{A}), the movements of the joints between the base body 200 and the first and second bodies 300 and 400 (θ_{E} and θ_{CE}), and the movements of the joints included in each of the first and second bodies 300 and 400 (θ_{CA}).

Here, the angular velocities ω_{A}, ω_{E}, ω_{CE}, and ω_{CA} may be calculated by using the angles θ_{A}, θ_{E}, θ_{CE}, and θ_{CA} of the joints output from the remote weapon system 10 and measured values ω_{X}, ω_{Y}, and ω_{Z} of the gyro sensor.

In calculating the controlling amounts, the controlling amounts i_{A}, i_{E}, i_{CE}, and i_{CA} may be calculated by receiving differences between the reference angular velocities ω_{ref}_{_{—}}_{A}, ω_{ref}_{_{—}}_{E}, ω_{ref}_{_{—}}_{CE}, and ω_{ref}_{_{—}}_{CA} of the joints and the calculated angular velocities ω_{A}, ω_{E}, ω_{CE}, and ω_{CA}. Then, the joints may be driven according to the controlling amounts i_{A}, i_{E}, i_{CE}, and i_{CA}.

Here, according to the controlling structure shown in FIG. 2, the last links in the first body 300 and the second body 400, for example, the weapon module 310 and the camera module 410, may be feedback-controlled to orient toward a set direction with respect to the movement of the base body 200. Therefore, the last links in the first body 300 and the second body 400, for example, the weapon module 310 and the camera module 410, may be stabilized so as to orient toward the set direction even when the base body 200 moves.

The angular velocities ω_{X}, ω_{Y}, and ω_{Z} of the base body 200 measured by the gyro sensor in response to a disturbance during stabilization are transformed into the angular velocities ω_{E} and ω_{CA} of the last links in the first and second bodies 300 and 400. The transformation may be performed when calculating the angular velocities.

A status of the remote weapon system 100 with respect to the absolute coordinate system is obtained by using one or more inclinometer sensors or accelerometers mounted on the base body 200 and the encoder sensor attached to each of the joints, and thus, the drift of the gyro sensor may be compensated.

Coordinate values of the last links in the first body 300 and the second body 400 with respect to the absolute coordinate system are obtained by using values measured by the inclinometer sensors or the accelerometers, the movements of the joints between the base body 200 and the first and second bodies 300 and 400, and the movements of the joints included in the first and second bodies 300 and 400, and then, an error of the gyro sensor may be compensated.

Therefore, the coordinate values of the last links in the first and second bodies 300 and 400 with respect to the absolute coordinate system are obtained by using the values measured by the inclinometer sensors or the accelerometers in order to compensate for the drift phenomenon of the gyro sensor.

Accordingly, even if a disturbance is applied to the remote weapon system 10 during shooting of the weapon module 310, the weapon module 310 may be stably maintained oriented toward a target.

Through the method (S10) for trajectory adjustment and/or lead compensation, the trajectory adjustment and/or lead compensation may be performed stably without regard to disturbances such as roads or waves affecting the vehicle, on which the remote weapon system 10 is mounted.

Here, sub-systems for performing various functions may be independently stabilized by using a single gyro sensor. In addition, the drift of the gyro sensor may be minimized even when a disturbance is applied to the remote weapon system 10 while the vehicle is moving.

The trajectory adjustment and/or lead compensation method (S10) may include operations of calculating a first rotating angle (S120), generating a first driving trajectory (S130 through S150), and driving the first body 300 (S160 and S170).

In calculating the first rotating angle (S120), a vertical and/or horizontal rotating angles of the first body 300 for making the first body 300 face the set orientation direction from a current orientation may be calculated. In operations S130 through S150, a driving trajectory of the first body 300 may be generated. In operations S160 and S170, the first body 300 may be driven according to the generated driving trajectory.

Here, the first and second bodies 300 and 400 may be controlled to face toward the same point in vertical and horizontal directions. That is, the weapon module 310 of the first body 300 and the camera module 410 of the second body 400 may be controlled to face toward the same point in the vertical and horizontal directions. To do this, the vertical and/or horizontal rotating angles of the weapon module 310 and those of the camera module 410 may be calculated in operation S120.

Then, a trapezoidal trajectory is initialized (S130), and it is determined whether the driving trajectory is set as the trapezoidal trajectory (S140). At this time, when the driving trajectory is set as the trapezoidal trajectory, the driving trajectory may be generated such that a variation rate of an angular velocity of each joint forms a trapezoid with respect to time (S150).

If the driving trajectory is not set as the trapezoidal trajectory, feed-back input values of the angular velocity of each joint are generated so that the first body 300, for example, the weapon module 310, orients toward a target orientation (S250).

In operation S110, it is determined whether the remote weapon system 10 returns to trajectory adjustment and/or lead compensation operations (S110). If it is determined that the remote weapon system 10 does not return to the trajectory adjustment and/or lead compensation operations, operation S120 for calculating the first rotating angle is performed. If, however, it is determined that the first and second bodies 300 and 400 return to the trajectory adjustment and/or lead compensation operations, return rotating angles of the first and second bodies 300 and 400 in vertical and/or horizontal directions are calculated (S220), and it is determined whether the driving trajectory is set to be the trapezoidal trajectory (S140).

Then, the weapon module 310 may be driven by controlling a velocity thereof (S170) until the trapezoidal trajectory is completed (S180). In addition, it is determined whether the current orientation of the weapon module 310 is the target orientation (S190), and the weapon module 310 may be driven (S170) until the current orientation of the weapon module 310 becomes the target orientation (S190). Here, it is determined whether a difference between the target orientation and the current orientation of the weapon module 310 is greater than a tolerable error to determine whether the current orientation of the weapon module 310 is the target orientation (S190).

If the difference is greater than the tolerable error, it is determined whether a trapezoidal angular velocity calculation is required due to the error (S210). If the trapezoidal angular velocity calculation is required, the trapezoidal trajectory initialization is performed (S130). In addition, if the angular velocity calculation is not required, it is determined whether the driving trajectory of the weapon module 310 is set as the trapezoidal trajectory (S140).

In addition, it is determined whether the trajectory adjustment and/or lead compensation are completed (S200), and then the method (S10) for the trajectory adjustment and/or lead compensation is finished when the trajectory adjustment and/or lead compensation are completed, and the weapon module 310 may be driven (S170) when the trajectory adjustment and/or lead compensation are not completed.

Therefore, the trajectory adjustment and/or lead compensation may be performed stably without regard to a disturbance such as a road or wave affecting the vehicle, on which the remote weapon system 10 is mounted, when operating the remote weapon system 10.

In calculating the first rotating angle (S120), the current orientation of the weapon module 310 is measured at a time when commands for the trajectory adjustment and/or lead compensation are executed, and then a weapon vector planned to perform the trajectory adjustment and/or lead compensation is calculated from the difference between the current orientation and the target orientation of the weapon module 310. A rotary movement for performing the trajectory adjustment and/or lead compensation is generated by using the weapon vector.

In addition, a rotating angle of each joint is calculated to generate the planned weapon vector. Here, the weapon vector is applied to a rotating portion of the weapon module 310, and a joint trajectory value is calculated through inverse kinematics.

The calculating of the return rotating angles in the vertical and/or horizontal directions (S220) may include operations of calculating a return value in the vertical direction and/or calculating a return value in the horizontal direction.

In the operation of calculating the return value in the vertical direction, an offset angle of a vector, on which the weapon module 310 and the camera module 410 are placed in parallel with each other, is a difference between current angles of the joints in the camera module 410 and the weapon module 310 read by using the encoders. Therefore, if the joints of the weapon module 310 or the camera module 410 are rotated by the difference, the weapon module 310 and the camera module 410 may be placed in parallel with each other.

In the calculating of the return value in the horizontal direction, the joints of the weapon module 310 or the camera module 410 are rotated in opposite directions so that the orientations of the weapon module 310 and the camera module 410 may be equal to each other.

An operation of generating a feedback input value of the angular velocities of the joints for making the weapon module 310 orient toward the target orientation (S250) includes operations of calculating the current orientation, calculating the target orientation, driving the weapon module 310, and a compensating operation.

In the calculating of the current orientation, the current orientation of the weapon module 310 may be calculated. In the calculating of the target orientation, the target orientation of the weapon module 310 may be calculated. In the driving operation, the joints of the weapon module 310 may be driven along with the trapezoidal trajectory. In the compensating operation, an error between the current orientation and the target orientation may be compensated by a feedback controlling operation.

The sub-systems having various functions in a single system may be independently stabilized by using a single gyro sensor. In addition, the drift of the gyro sensor may be minimized while a disturbance is applied to the vehicle while the vehicle is moving.

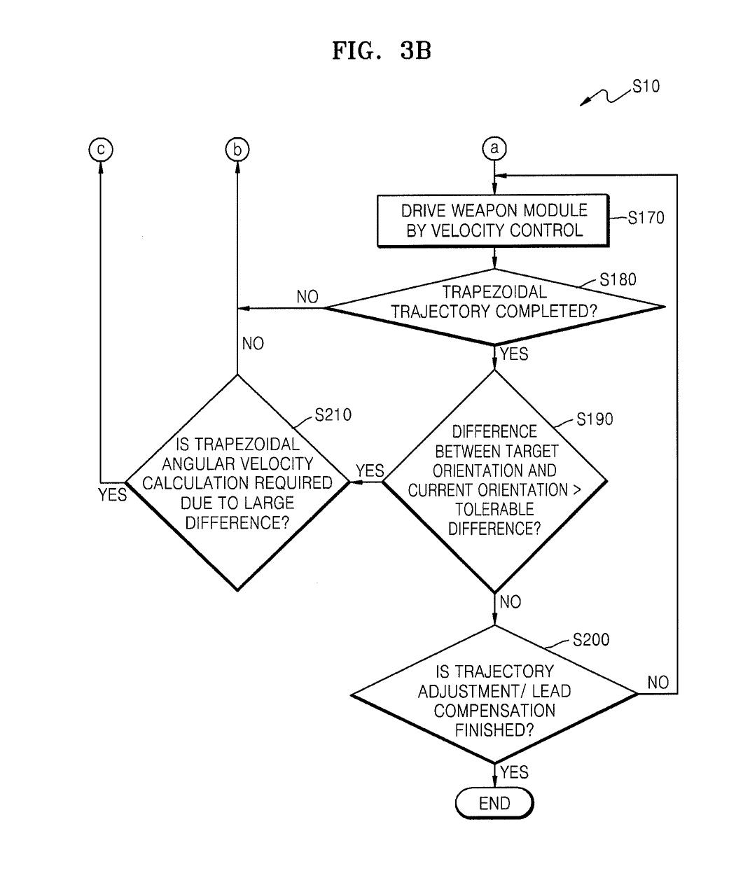

FIGS. 4 through 6 schematically illustrate the trajectory adjustment performed by the remote weapon system 10 of FIG. 1. Referring to the drawings, if the supporting body 100 maintains a set orientation constantly while there is no disturbance, the angle θ_{E} of the joint corresponding to the weapon module 310 may be adjusted to perform the trajectory adjustment in the exemplary embodiment shown in FIG. 1. Accordingly, the weapon module 310 may maintain a vector constantly with respect to the absolute coordinate system.

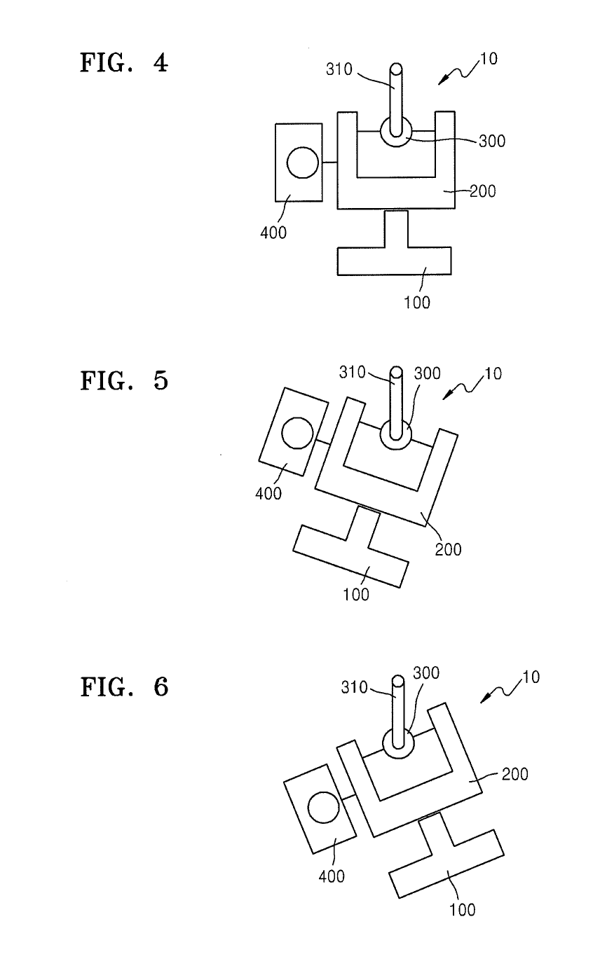

FIGS. 5 and 6 are diagrams illustrating the trajectory adjustment performed by the remote weapon system 10 of FIG. 1 against disturbances. Referring to FIGS. 5 and 6, an orientation of the supporting body 100 may be distorted due to a disturbance. In this case, the orientation of the weapon module 310 may be adjusted in a three-dimensional way in consideration of the distortion of the supporting body 100.

To do this, by adjusting the angle θ_{A} of joint of the base body 200, as well as the angle θ_{E} of the joint of the weapon module 310, the trajectory adjustment in the three-dimensional way is performed. Accordingly, in a case where the orientation of the supporting body 100 is distorted by a disturbance, the weapon module 310 may maintain the vector constantly with respect to the absolute coordinate system.

According to the exemplary embodiments, at least one or more link structures are kinematically connected to a common base body, and each of the link structures may be independently stabilized by using a sensor mounted on the base body.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A multi-linkage and multi-tree structure system, the system comprising:
a base body comprising a sensor for detecting movement of the base body; and
at least one link body which is connected to the base body via at least one first joint and moves relative to the base body with respect to at least one axis,
wherein movement of the at least one link body is independently controlled based on the movement of the base body detected by the sensor, and
wherein each of the at least one link body comprises one or more links that are connected to one another via at least one second joint, and at least one link in each of the at least one link body is controlled to orient toward a set direction with respect to the movement of the base body.

2. The system of claim 1, wherein the at least one link, which is controlled to orient toward the set direction with respect to the movement of the base body, is at least one last link included in the at least one link body, respectively.

3. The system of claim 2, wherein the movement of the base body detected by the sensor is transformed into movement of the at least one last link by reflecting movements of the at least one first joint and the at least one second joint.

4. The system of claim 1, wherein the sensor comprises at least one of a gyro sensor for measuring an angular velocity of the base body with respect to at least one axis, an inclinometer sensor for measuring a rotating angle with respect to the at least one axis, and a rotation detector.

5. The system of claim 4, wherein coordinate values of at least one last link respectively included in the at least one link body with respect to an absolute coordinate system are obtained by using a value measured by the inclinometer sensor and movements of the at least one first joint and the at least one second joint, to compensate for an error caused by the gyro sensor.

6. The system of claim 1, further comprising:
an angular velocity calculator for calculating angular velocities of at least one third joint connecting the base body and a fixed body on which the base body is fixed, the at least one first joint and at least one second joint by using the movement of the base body and movements of the at least one first joint and the at least one second joint;
a controller for receiving differences between reference angular velocities and the calculated angular velocities to calculate controlling amounts; and
a driver for driving the at least one first joint, the at least one second joint and the at least one third joint, according to the controlling amounts.

7. The system of claim 6, wherein the at least one first joint, the at least one second joint and the at least one third joint are driven so that variation rates of the calculated angular velocities form a trapezoidal shape with respect to time.

8. The system of claim 6, wherein the movement of the base body and the movements of the at least one first joint and the at least one second joint are measured by respective angles of rotation, and
wherein the angular velocity calculator calculates the angular velocities of the at least one first joint, the at least one second joint and the at least one third joint by further using angular velocities of the base body calculated by the sensor.

9. The system of claim 1, wherein the base body is mounted on a vehicle, a weapon module is mounted on one of the at least one link body, and a camera module is mounted on another one of the at least one link body.

10. The system of claim 1, wherein the at least one link body comprises two or more link bodies,
wherein the at least one link, which is controlled to orient toward the set direction with respect to the movement of the base body, is at least one of last links respectively included in the two or more link bodies, and
wherein the movement of the base body detected by the sensor is transformed into movements of the last links included in the two or more link bodies by reflecting movements of the at least one first joint and the at least one second joint.

11. A method of controlling a multi-linkage and multi-tree structure system, in which at least one link body is connected to a base body via at least one first joint, wherein the at least one link body is capable of moving relative to the base body, and the base body comprises a sensor for detecting movement of the base body, the method comprising:
controlling movement of the at least one link body independently based on the movement of the base body detected by the sensor,
wherein each of the at least one link body comprises one or more links that are connected to one another via at least one second joint, and at least one link in each of the at least one link body is controlled to orient toward a set direction with respect to the movement of the base body.

12. The method of claim 11, wherein the at least one link, which is controlled to orient toward the set direction with respect to the movement of the base body, is at least one last link respectively included in the at least one link body.

13. The method of claim 12, wherein the movement of the base body detected by the sensor is transformed into movement of the at least one last link by reflecting movements of the at least one first joint and the at least one second joint.

14. The method of claim 11, further comprising:
calculating angular velocities of at least one third joint connecting the base body and a fixed body on which the base body is fixed, the at least one first joint and the at least one second joint by using the movement of the base body and movements of the at least one first joint and the at least one second joint;
receiving differences between reference angular velocities and the calculated angular velocities and calculating controlling amounts; and
driving the at least one first joint, the at least one second joint and the at least one third joint, according to the controlling amounts.

15. The method of claim 14, wherein the movement of the base body and the movements of the at least one first joint and the at least one second joint are measured by respective angles of rotation, and
wherein the angular velocities of the at least one first joint, the at least one second joint and the at least one third joint are calculated by further using angular velocities of the base body calculated by the sensor.

16. The method of claim 11, wherein coordinate values of at least one last link included in the at least one link body, respectively, with respect to an absolute coordinate system are obtained by using a value measured by an inclinometer sensor installed in the base body and movements of the at least one first joint and the at least one second joint, to compensate for an error caused by a gyro sensor.

17. The method of claim 11, further comprising:
calculating a rotating angle of a first body, among the at least one link body comprising the first body and a second body, in a vertical direction and a horizontal direction to change a current orientation of the first body to a target orientation;
generating a driving trajectory of the first body; and
driving the first body according to the driving trajectory.

18. The method of claim 17, further comprising controlling the first body and a second body of the at least one link body to face the same orientation in the vertical and horizontal directions.

19. The method of claim 17, comprising:
generating the driving trajectory such that variation rates of angular velocities of at least one third joint connecting the base body and a fixed body on which the base body is fixed, the at least one first joint and the at least one second joint form a trapezoidal shape with respect to time; and
generating feedback input values of the angular velocities so that the first body faces the target orientation.

20. The method of claim 11, further comprising:
calculating a current orientation of the first body;
calculating a target orientation of the first body;
driving the first body along with a trapezoidal trajectory; and
compensating for a difference between the current orientation and the target orientation by feedback controlling.

21. A multi-linkage apparatus comprising:
a base body movably connected to a moving vehicle, the base body comprising a sensor for detecting movement of the base body with respect to the moving vehicle;
at least one link body which is connected to the base body via at least one first joint; and
a controller which controls the at least one link body to move relative to the base body, and controls at least one link included in the at least one link body to orient toward a predetermined direction regardless of orientation of the base body, based on the movement of the base body detected by the sensor.

22. The apparatus of claim 21, wherein the at least one link body comprises two or more link bodies, and
wherein the controller controls one link included in each of the two or more link bodies to orient toward the predetermined direction regardless of orientation of the base body, based on the movement of the base body detected by the sensor.
